(19) United States
(12) Patent Application Publication
(10) Pub. No.: US 2026/0029863 A1
(43) Pub. Date: Jan. 29, 2026

(54) MODULAR MOUSEPAD ASSEMBLY WITH INTERCHANGEABLE FABRIC SURFACE AND FOAM INSERT

(71) Applicant: Joshua Moore, Jacksonville, FL (US)

(72) Inventor: Joshua Moore, Jacksonville, FL (US)

(21) Appl. No.: 19/229,715

(22) Filed: Jun. 5, 2025

Related U.S. Application Data
(63) Continuation-in-part of application No. 18/781,734, filed on Jul. 23, 2024, now abandoned.

(51) Int. Cl. G06F 3/039

(52) U.S. Cl. CPC G06F 3/0395

(57) ABSTRACT

A modular mousepad assembly is disclosed, including a foam insert and a fabric layer connected to one another and retained in position using cohesion. A top frame and a bottom frame may be magnetically connected and retain the foam insert and fabric layer therebetween. The magnetic connection between the top frame and the bottom frame enables a user to efficiently and readily replace the foam insert and the fabric layer to customize the comfort and mouse performance while the mouse is being moved over the modular mousepad assembly.

### CROSS-REFERENCE TO RELATE APPLICATIONS

This application is a Continuation-In-Part of U.S. patent application Ser. No. 18/781,734 filed on Jul. 23, 2024 which is incorporated herein by reference in its entirety.

### TECHNICAL FIELD

The embodiments disclosed herein generally relate to mousepads and more specifically to modular mousepads having interchangeable components.

### BACKGROUND

A computer mouse is used to interact with a cursor on the digital display of a computer. When first developed, optical mice use image sensors to detect movement and required special mousepads with optical patterns printed on them. Modern optical mice have advanced to enable their function on a variety of surfaces.

Mousepads are surfaces for placing and moving a computer mouse. They are commonly used to enhance the usability of the mouse compared to using the mouse directly on a desk or table. Mousepads aid in improving the measurement of the mouses movement while reducing jitters and jumping of the cursor which corresponds to the movement of the mouse. Further, mousepads increase the speed at which the mouse can accurately be moved as well as provide comfort to the user. They may also help reduce dust collection under the mouse.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a modular mousepad assembly, including a foam insert and a fabric layer. The fabric layer provides a surface on which a mouse is used.

In one aspect, the assembly includes a top frame and a bottom frame having the foam insert and fabric layer positioned therebetween. The magnetic connection between the top frame and the bottom frame enables a user to efficiently and readily replace the foam insert and the fabric layer to customize the comfort and mouse performance while the mouse is being moved over the modular mousepad assembly.

In some aspects, the modular mousepad assembly includes a suction-based adhesion mechanism formed between the foam insert and the fabric layer. The suction-based adhesion is achieved by pressing the fabric layer against the upper surface of the foam insert, displacing air and forming a low-pressure interface. This interface generates a temporary yet reliable vacuum effect that secures the fabric layer in place without requiring permanent adhesives, stitching, or mechanical fasteners. The result is a seamless, uninterrupted mousing surface with no creases or shifting during use.

In some embodiments, the upper surface of the foam insert is treated with a polymeric coating, such as glossy polyurethane or a thermoplastic elastomer, which enhances the cohesion between the foam and fabric layers. This coating provides a smooth and flexible contact surface that conforms to the underside of the fabric layer, improving suction performance and allowing for repeated attachment and detachment without degradation. The suction interface contributes to both ergonomic performance and ease of maintenance, making the modular mousepad assembly particularly well-suited for high-usage or shared environments.

In some aspects, the suction-based adhesion mechanism provides improved structural integrity of the assembly during use. The suction effect maintains uniform tension across the entire surface of the fabric layer, minimizing the risk of slippage or displacement during rapid or forceful mouse movements. This improves precision and consistency, particularly in contexts requiring high mouse sensitivity such as gaming or graphic design. Additionally, the interior region of the mousepad remains equally secured, complementing the peripheral magnetic frame that holds the overall assembly together.

In some embodiments, the suction-based adhesion mechanism works independently or in conjunction with the magnetic locking system between the top frame and bottom frame. While the magnetic system provides edge retention and structural stability, the suction layer prevents internal shifting between the foam and fabric components. This cooperative design ensures a stable, secure surface while retaining the user-friendly modularity that enables frequent replacement or customization of mousepad elements.

In some aspects, the suction mechanism supports improved hygiene and prolonged product life. Because the adhesion is non-permanent and residue-free, the fabric layer can be easily removed for washing, replacement, or inspection. This allows users to maintain a clean and fresh mousepad surface without damaging the foam insert or requiring the use of solvents or scraping tools. The reusable nature of the suction mechanism also reduces waste and contributes to the long-term durability of the modular mousepad system.

In some aspects, the assembly includes a magnetic locking mechanism for improved frame retention.

In some aspects, the system includes a suction-based adhesion layer between the foam insert and fabric layer to prevent shifting between layers, ensuring the fabric layer stays in position during use.

In some aspects, the system allows for compatibility with modular accessories, including wrist rests and cooling inserts.

In some aspects, the system utilizes antimicrobial and/or moisture resistant fabric coatings.

In one aspect, the top frame further comprises a plurality of first magnetic components mounted to a top channel.

In one aspect, the bottom frame further comprises a plurality of second magnetic components mounted to a bottom edge.

In one aspect, the top channel is dimensioned to receive and magnetically engage with the bottom edge.

In one aspect, the bottom frame includes a central portion providing a surface to receive the foam insert thereon.

In one aspect, the central portion is dimensioned to at least partially receive the foam insert within an inner perimeter of the bottom edge.

In one aspect, the fabric layer is positioned on top of the foam insert.

In one aspect, the top frame and the bottom frame magnetically retain the foam insert and the fabric layer therebetween.

In one aspect, the fabric layer is bendable to retain the foam insert and the fabric layer between the top frame and the bottom frame.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1A illustrates a perspective view of the top of the fabric layer of the modular mousepad assembly, according to some embodiments;

FIG. 1B illustrates a perspective view of the bottom of the fabric layer of the modular mousepad assembly, according to some embodiments;

FIG. 2 illustrates a perspective view of the foam insert of the modular mousepad assembly, according to some embodiments;

FIG. 3 illustrates a perspective view of the top frame of the modular mousepad assembly, according to some embodiments;

FIG. 4 illustrates a perspective view of the bottom frame of the modular mousepad assembly, according to some embodiments;

FIG. 5A illustrates a perspective view of the bottom frame when assembling the modular mousepad assembly, according to some embodiments;

FIG. 5B illustrates a perspective view of the foam insert positioned on the bottom frame when assembling the modular mousepad assembly, according to some embodiments;

FIG. 5C illustrates a perspective view of the fabric layer positioned on the foam insert and bottom frame when assembling the modular mousepad assembly, according to some embodiments;

FIG. 5D illustrates a perspective view of the fabric layer suctioned to the foam insert when assembling the modular mousepad assembly, according to some embodiments;

FIG. 5E illustrates a perspective view of the top frame being connected to the bottom frame when assembling the modular mousepad assembly, according to some embodiments;

FIG. 5F illustrates a perspective view of the assembled modular mousepad assembly, according to some embodiments;

FIG. 6 illustrates a cross-section of the assembled modular mousepad assembly, according to some embodiments; and

FIG. 7 illustrates an exploded view of the modular mousepad assembly, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a modular mousepad assembly having an interchangeable foam insert and fabric layer to allow the user to adjust the texture and firmness based on their personal preferences. The modular mousepad assembly includes a bottom frame, a top frame, a foam insert, and a fabric layer each designed to be interchangeable for cleaning, maintenance, and selection of firmness and texture.

In some embodiments, the assembly includes a foam insert and a fabric layer which are suctioned to one another. The foam insert and fabric layers are connected using cohesion provided by the glossy polyurethane materials which contact one another.

The modular mousepad assembly allows the user to select from various surface textures provided by the fabric layer. The modular mousepad assembly may be capable of receiving fabric layers having various textures, colors, and other aesthetic qualities to provide a customizable surface and appearance. Selection of the fabric layer may be based on user preferences and mouse movement preferences. For example, a smoother fabric can facilitate quick mouse movements with less friction which may be ideal of fast-paced gaming. A rougher texture provides more resistance to movement and increased control of the mouse movements.

The modular mousepad assembly allows users to select from various foam insert characteristics, such as to alter the firmness of the foam insert. Foam inserts may be provided in a variety of firmness options from soft to firm, enabling users to select the support provided by the foam insert. Altering the firmness of the foam insert allows the user to select a foam insert suitable for providing the most comfort while using the mouse.

The modular mousepad assembly is constructed for a wide variety of uses and activities. For example, the user may configure the modular mousepad assembly with a smooth fabric surface and firm foam insert to facilitate quick movements while gaming. The modular mousepad assembly may then be readily reconfigured having a rough fabric layer texture and a soft foam insert for increased comfort while performing daily tasks on the computer, such as casual content consumption. In such, the modular mousepad assembly is efficiently and readily configured to meet ergonomic needs and performance needs. Further, the modular mousepad assembly is easily disassembled to allow the user to clean the mousepad, or otherwise perform maintenance. The customizable and reconfigurable construction of the modular mousepad assembly may also enable the user to customize the aesthetic appearance of the assembly.

In certain embodiments, the suction-based adhesion mechanism operates by leveraging the smooth, non-porous surface interaction between the upper surface of the foam insert and the underside of the fabric layer. When the fabric layer is pressed firmly onto the foam insert, air is displaced from the interface, creating a temporary vacuum seal that resists lateral motion. This seal is particularly effective when one or both of the contacting surfaces include a thin, flexible polymer coating, such as a glossy polyurethane or thermoplastic elastomer. The suction effect generated at this interface prevents the fabric layer from shifting during mouse operation, enhancing both the tactile consistency and ergonomic reliability of the modular mousepad assembly.

The suction mechanism eliminates the need for permanent adhesives, mechanical fasteners, or hook-and-loop systems, all of which can introduce surface irregularities or degrade over time. Instead, the suction-based adhesion provides a reconfigurable and reusable connection that allows users to quickly swap out fabric layers to accommodate different textures, styles, or use environments. For instance, a user may wish to replace a smooth, fast-glide fabric layer with a coarser, high-friction alternative depending on the application, such as gaming versus precision graphic design. The ability to rapidly disengage and reattach fabric layers using only fingertip pressure ensures that the suction-based system enhances usability without compromising structural integrity.

In some embodiments, the upper surface of the foam insert includes a thin elastomeric film that is both compliant and resilient. This film conforms to micro-contours on the fabric's underside, further promoting surface contact and optimizing the suction seal. The dynamic nature of this bond permits the fabric layer to remain flush and wrinkle-free even after repeated detachment and reattachment cycles. The suction layer also contributes to the quiet operation of the mousepad, absorbing micro-vibrations and minimizing noise during rapid or forceful mouse movements.

The suction-based adhesion mechanism may operate independently or in conjunction with the magnetic locking system provided by the top and bottom frames of the assembly. While the magnetic frames primarily secure the perimeter of the fabric and foam components, the suction layer prevents movement within the interior region of the mousepad. This dual-securing system enables consistent surface stability across the entire mousing area, especially during high-speed or high-pressure use. Notably, the suction mechanism ensures that the central area of the mousepad remains equally secure, avoiding performance degradation from sagging, bubbling, or mid-use misalignment.

Further still, the suction interface provides advantages in maintenance and hygiene. Users can remove and replace the fabric layer without leaving behind adhesive residue or requiring cleaning solvents. This is especially valuable in environments where cleanliness is critical, such as shared workspaces or healthcare settings. Because the suction mechanism is inherently non-invasive and residue-free, it supports the long-term integrity of both the foam insert and fabric layer, reducing material fatigue and enabling a longer functional lifespan for each component.

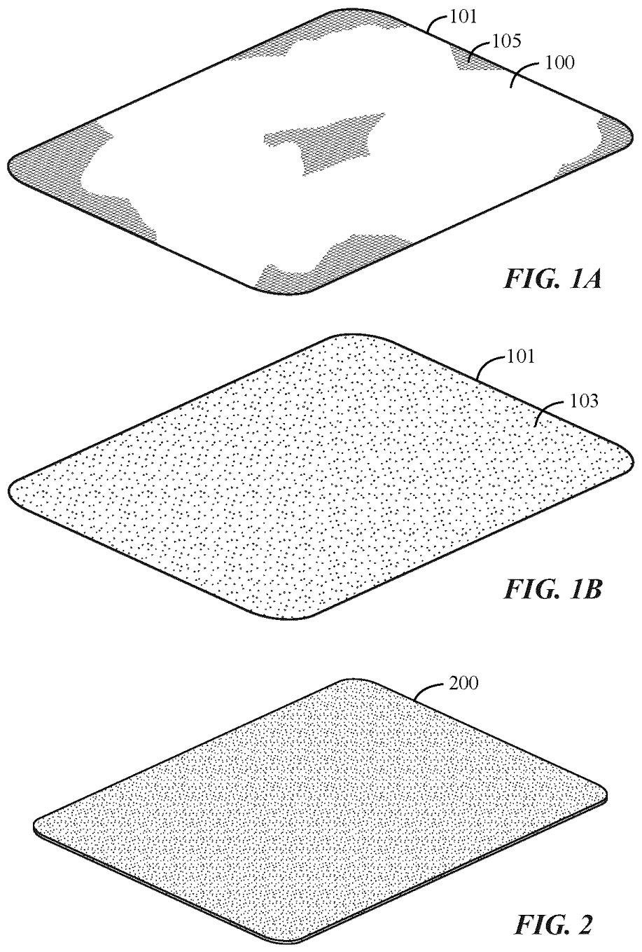

FIG. 1A illustrates the top surface 100 of the fabric layer 101 of the modular mousepad assembly. FIG. 1B illustrates the bottom surface 103 of the fabric layer 101. Each fabric layer 101 can be selected and replaced by the user such that the user can select the texture 105 of the top surface 100. This enables the user to select between a range of smooth textures and rough textures to alert the performance, feel, and characteristics of a mouse being used on the top surface 100 of the modular mouse pad assembly. The bottom surface 103 may be constructed having a similar texture as the top surface 100 or a different texture and/or material. For example, a rough texture may be beneficial on the bottom surface 103 such that it remains in a fixed position when positioned above and when contacting the foam insert.

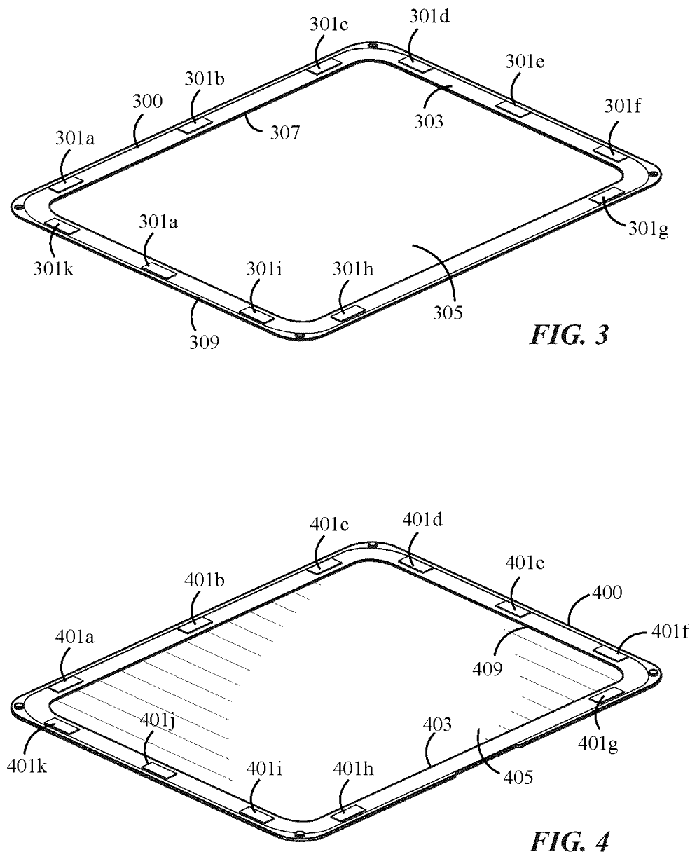

FIG. 2 illustrates the foam insert 200 of the modular mousepad assembly. The foam insert 200 can be constructed of various materials to enable the user to alter the firmness of the foam insert 200, thus changing the feel and comfort provided by the foam insert 200. For example, the foam insert 200 may be constructed of a firm (i.e., denser) foam, or a soft (i.e., less dense) foam material.

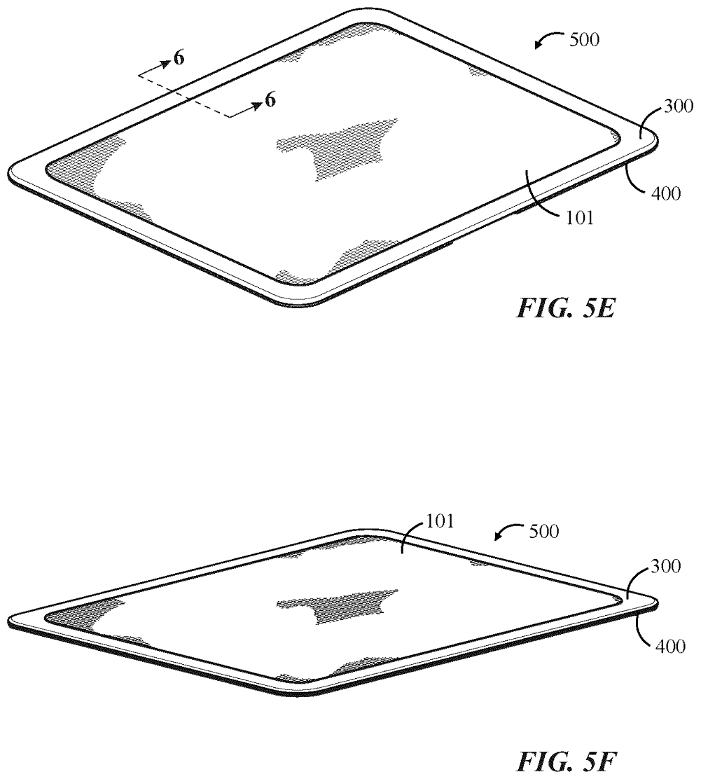

In some embodiments, the foam insert 200 and fabric layer 101 are releasably connected via a suction-based adhesion mechanism formed by suctioning the foam insert 200 to the fabric layer 101. The suction-based adhesion mechanism may be formed by causing a suction force between a top layer 270 of the foam insert (see FIG. 5B) and a bottom layer of the fabric layer 101.

In some embodiments of the modular mousepad assembly, the suction-based adhesion mechanism is used to secure the fabric layer to the underlying foam insert without requiring adhesives, fasteners, or stitching. This mechanism leverages the surface interaction between the underside of the fabric layer and the upper surface of the foam insert, which is optionally treated with a glossy polyurethane or thermoplastic elastomer coating. When the two surfaces are pressed together, the air between them is displaced, and a low-pressure zone is created, effectively forming a temporary bond through suction.

This suction-based attachment provides a number of distinct benefits over conventional connection methods. First, it enables a seamless and flush interface between the fabric and foam components, preserving a smooth mousing surface without creases, bulges, or uneven transitions. Second, the mechanism supports quick and effortless replacement or cleaning of the fabric layer. Users can simply lift the layer from one edge to release the suction and swap it with another fabric type, texture, or color. This is particularly advantageous for environments requiring hygiene, such as shared workstations, healthcare settings, or gaming tournaments.

From an ergonomic perspective, the suction-based adhesion enhances the performance of the modular mousepad assembly by preventing slippage during intense mouse movements, such as those experienced during gaming or design work. Unlike adhesives that may degrade or leave residue over time, the suction mechanism is reusable and leaves no marks on either component. Furthermore, because the suction does not rely on external hardware or complex alignment structures, it reduces manufacturing complexity and contributes to the modular, user-customizable nature of the assembly.

This mechanism may be used independently or in combination with the frame-based magnetic locking system described herein. While the magnetic frame provides peripheral stability by clamping the fabric and foam between the top and bottom frames, the suction layer reinforces interior stability and minimizes internal motion. Together, the two mechanisms cooperate to deliver a secure yet fully reversible fastening solution that supports ergonomic performance, material interchangeability, and long-term durability of the modular mousepad assembly.

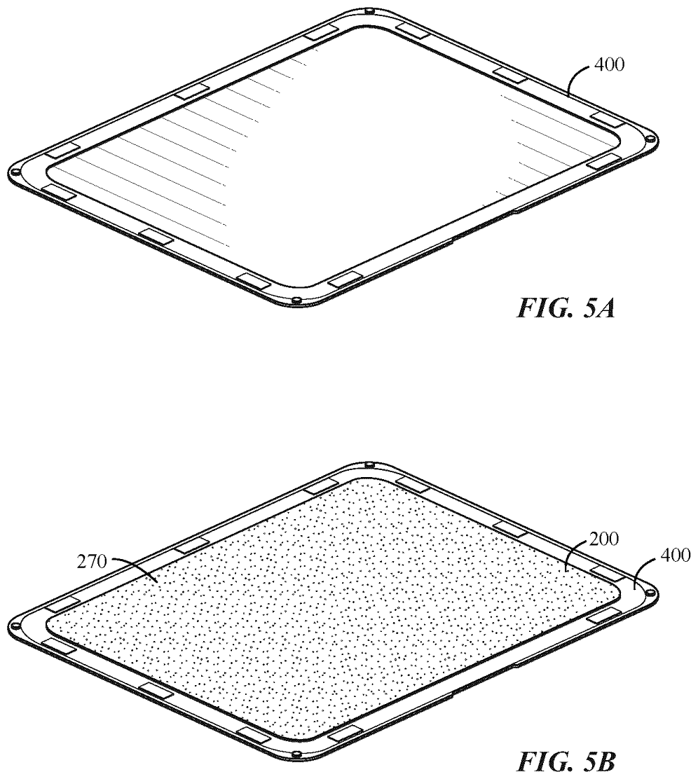

FIG. 3 illustrates top frame 300 of the modular mousepad assembly. The top frame 300 includes a plurality of first magnetic components 301a, 301b, 301c, 301d, 301e, 301f, 301g, 301h, 301i,301j, 301k positioned within a top channel 303. The top frame 300 includes an opening 305 defined by an inside perimeter 307 of the rim 309. The opening allows for the top surface of the fabric layer to be exposed such that the mouse may contact the top surface of the fabric layer during use of the mouse.

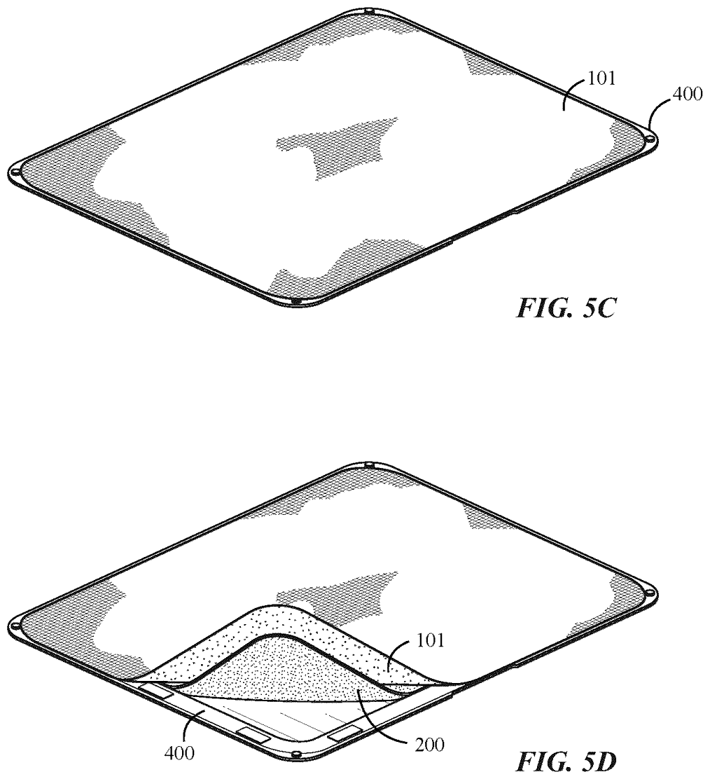

FIG. 4 illustrates the bottom frame 400 of the modular mousepad assembly. The bottom frame 400 includes a plurality of second magnetic components 401a, 401b, 401c, 401d, 401e, 401f, 401g, 401h, 401i, 401j, 401k positioned on a bottom edge 403 such that they magnetically engage with the first magnetic components on the top frame. The bottom frame 400 includes a base 405 wherein on foam insert is placed. The bottom edge 403 is slightly raised above the base 405 to receive the foam insert within an inner perimeter 407 of the bottom edge 403.

FIGS. 5A-5F illustrate views of various steps for assembling the modular mousepad assembly. In particular FIG. 5A illustrates the bottom frame 400. In FIG. 5B, the foam insert 200 is positioned on the bottom frame 400. In FIG. 5C, the fabric layer 101 is positioned on top of the foam insert. FIG. 5D illustrates the layering of the bottom frame 400, foam insert 200, and fabric layer 101. In some embodiments, the fabric layer 101 may be suctioned to the foam insert 200 to retain the fabric layer 101 in a fixed position on top of the foam insert 200. FIGS. 5E and 5F illustrate the top frame 300 being connected to the bottom frame 400 to retain the foam insert and fabric layer 101 therebetween to form the modular mousepad assembly 500 in an in-use configuration 501.

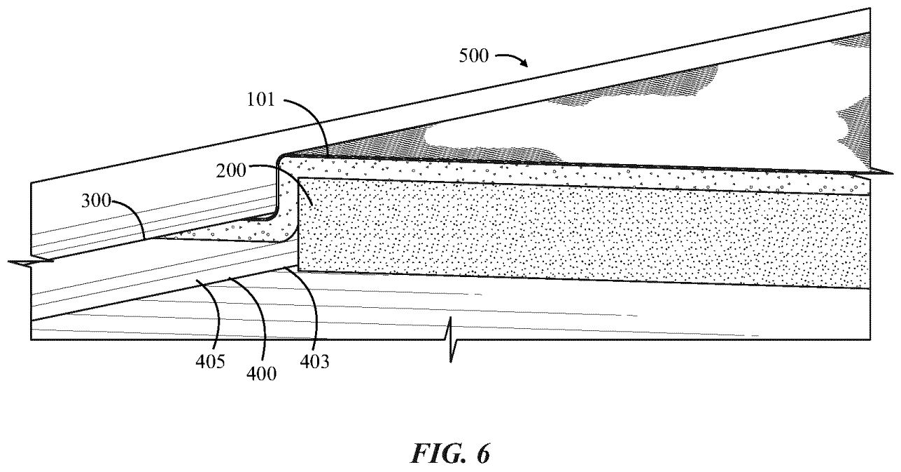

FIG. 6 illustrates a cross-section of the assembled modular mousepad assembly 500 including the fabric layer 101, foam insert 200, top frame 300, and bottom frame 400. The fabric layer 101 is illustrated being bent over the edges of the foam insert 200 such that the fabric layer is pressed between the top frame 300 and the bottom frame 400. In such, the foam insert 200 is retained within the inner edge 405 of the bottom edge 403 of the bottom frame 200. The fabric layer 101 is constructed of a sufficiently flexible material to bend over the top edges of the foam insert 200 such that the foam insert 200 is held down by pressure applied by the fabric layer 101. The top frame 300 and the bottom frame 400, when magnetically connected to one another form an interior space 600 which accepts the fabric layer 101 therebetween.

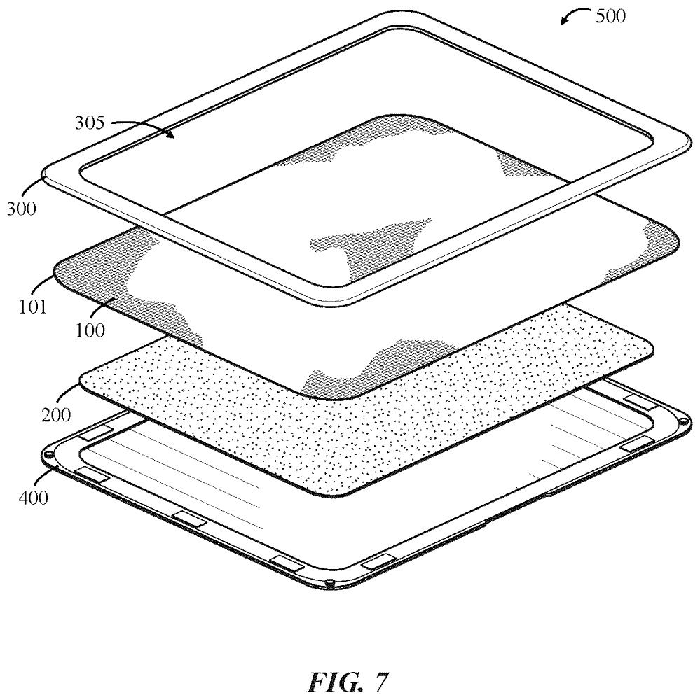

FIG. 7 illustrates an exploded view of the modular mousepad assembly 500 to show the orientation of each component of the assembly. The top surface 100 of the fabric layer is at least partially exposed through the opening 305 of the top frame 300. The foam insert 200 is positioned between the fabric layer 101 and the bottom frame 400.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A modular mousepad assembly, comprising:
a foam insert and a fabric layer secured using a suction-based adhesion mechanism, wherein the foam insert includes a coating that creates a non-permanent adhesive force with the fabric layer to prevent unintended movement during use.

2. The modular mousepad assembly of claim 1, further comprising a top frame and a bottom frame, wherein the top frame includes a plurality of rare-earth magnets mounted within a recessed top channel, and the bottom frame comprises complementary magnetic elements aligned for uniform retention strength while allowing for user-friendly disassembly.

3. The modular mousepad assembly of claim 2, wherein the bottom frame further comprises a plurality of second magnetic components mounted to a bottom edge.

4. The modular mousepad assembly of claim 3, wherein the top channel is dimensioned to receive and magnetically engage with the bottom edge.

5. The modular mousepad assembly of claim 4, wherein the bottom frame includes a central portion providing a surface to receive the foam insert thereon.

6. The modular mousepad assembly of claim 5, wherein the central portion is dimensioned to at least partially receive the foam insert within an inner perimeter of the bottom edge.

7. The modular mousepad assembly of claim 6, wherein the fabric layer is positioned on top of the foam insert.

8. The modular mousepad assembly of claim 7, wherein the top frame and the bottom frame magnetically retain the foam insert and the fabric layer therebetween.

9. The modular mousepad assembly of claim 8, wherein the fabric layer is bendable to retain the foam insert and the fabric layer between the top frame and the bottom frame.

10. The modular mousepad assembly of claim 1, wherein the fabric layer is selected from a group consisting of antimicrobial-coated textiles, moisture-resistant fabrics, and thermally conductive materials to enhance performance, hygiene, and durability.

11. A modular mousepad assembly, comprising:
a foam insert and a fabric layer each positioned between a top frame and a bottom frame, the foam insert, and the fabric layer secured via a suction-based adhesion mechanism;
a plurality of first magnetic components positioned on the top frame; and
a plurality of second magnetic components positioned on the bottom frame,
wherein the plurality of first magnetic components and the plurality of second magnetic components magnetically connect the top frame to the bottom frame.

12. The modular mousepad assembly of claim 11, wherein the plurality of first magnetic components are mounted to a top channel.

13. The modular mousepad assembly of claim 12, wherein plurality of second magnetic components are mounted to a bottom edge.

14. The modular mousepad assembly of claim 13, wherein the top channel is dimensioned to receive and magnetically engage with the bottom edge.

15. The modular mousepad assembly of claim 14, wherein the bottom frame includes a central portion providing a surface to receive the foam insert thereon.

16. The modular mousepad assembly of claim 15, wherein the central portion is dimensioned to at least partially receive the foam insert within an inner perimeter of the bottom edge.

17. A modular mousepad assembly, comprising:
a foam insert having an upper surface;
a fabric layer having a bottom surface positioned on the upper surface of the foam insert; and
a suction-based adhesion mechanism formed between the upper surface of the foam insert and the bottom surface of the fabric layer,
wherein the suction-based adhesion mechanism secures the fabric layer to the foam insert by creating a low-pressure interface upon contact, without the use of permanent adhesives, fasteners or stitching.

18. The modular mousepad assembly of claim 17, wherein the suction-based adhesion mechanism allows for the fabric layer to be repeatedly removed and reattached without degrading the adhesion performance.

19. The modular mousepad assembly of claim 17, wherein the suction-based adhesion mechanism is operable to prevent lateral shifting of the fabric layer relative to the foam insert during use of a computer mouse.

20. The modular mousepad assembly of claim 17, wherein the fabric layer is bendable and configured to conform over edges of the foam insert while being retained in place by the suction-based adhesion mechanism.
